(19) United States
(12) Patent Application Publication
(10) Pub. No.: US 2017/0158302 A1
(43) Pub. Date: Jun. 8, 2017

(54) Portable Powered Ventilator

(71) Applicant: Chad Allen Warren, Mukilteo, WA (US)

(72) Inventor: Chad Allen Warren, Mukilteo, WA (US)

(21) Appl. No.: 15/344,522

(22) Filed: Nov. 6, 2016

Related U.S. Application Data
(60) Provisional application No. 62/264,643, filed on Dec. 8, 2015.

(51) Int. Cl. B63J 2/02; H02S 20/30; H02S 10/40

(52) U.S. Cl. CPC B63J 2/02; H02S 10/40; H02S 20/30

(57) ABSTRACT

A portable powered ventilator to provide fresh air inflow to an enclosed space such as a covered boat. A powered ventilator includes a fan, located within a fan housing assembly that is connected to a duct. The duct is flexible and semi-rigid, which allows it to be formed into a desired shape suitable. The duct can be shaped to a longitudinal compact form for storage. The fan can be connected to a solar panel via a long cord, enabling the solar panel to be placed away from the fan. The solar panel can be bordered with foam rubber to protect it from damage. The solar panel can have an attached adjustable strap to secure the solar panel. Fresh air is drawn into the fan housing assembly and expelled through the duct into the covered enclosed space, thereby drying the boat interior and inhibiting the formation of mold and mildew.

### CROSS-REFERENCE TO RELATED APPLICATION

62/264,643

### REVELANT REFERENCES

The following is a tabulation of some references that presently appears revelant.

U.S. Patents

| Pat. No. | Kind Code | Issue Date | Patentee |
|---|---|---|---|
| 6,939,219 | B1 | 2005 Sep. 6 | Pollen |
| 6,167,658 | B1 | 2001 Jan. 2 | Weiner |
| 8,736,223 | B2 | 2014 May 27 | Kimble |
| 4,922,557 | | 1990 May 8 | Harding |
| 4,899,645 | | 1990 Feb. 13 | Wolfe |

U.S. Patent Application Publications

| Publication Nr. | Kind Code | Publ. Date | Applicant |
|---|---|---|---|
| 2012/0178357 | A1 | 2012 Jul. 12 | Rheume |

### BACKGROUND

Boats are often covered and stored after use while the interior is still wet, which can lead to the formation of mold and mildew. While some boat covers include passive vents, such passive vents typically provide inadequate airflow to sufficiently inhibit the formation of mold and mildew. In an effort to solve this issue, a ventilation system such as disclosed in U.S. Pat. No. 6,167,658 employs pressurized air to inflate the boat cover and correspondingly provide ventilation. The system disclosed in U.S. Pat. No. 6,167,658, however, relies on a very tight fit of the cover to the boat to achieve pressurization, and thus the ability to utilize such a system on a variety of boat shapes and sizes is extremely limited. Furthermore, most boat owners would prefer to use their existing cover for convenience and cost savings.

To accommodate the use of an existing cover, a ventilation system disclosed in U.S. Pat. No. 6,939,219 employs a powered ventilator incorporated into a housing that attaches to a support pole for the boat cover. While the ventilation system disclosed in U.S. Pat. No. 6,939,219 allows the boat owner to utilize an existing cover, it has numerous disadvantages. First, a hole must be cut into the existing cover to allow placement of the ventilator housing. Many boat owners utilize an expensive custom cover that came with the boat, and they would be reluctant to cut a hole in it. Furthermore, even if the boat owner utilizes a less expensive cover such as a tarp and is therefore willing to irreversibly alter it, the effort necessary to modify the cover is undesirable. A second disadvantage of this system is that the relatively large ventilator housing becomes permanently incorporated into the boat cover. When a boat is used, the cover is often folded and crammed into a tight compartment within the boat. Having the ventilator housing incorporated into the cover may make storage difficult or impossible, and furthermore puts the ventilator housing at risk of damage if the cover if forced into a tight compartment. A third disadvantage of this system is the location and size of the solar panel in the preferred embodiment detailed in the patent. The solar panel is permanently attached to the top of the ventilator housing. This greatly restricts the size of the solar panel, and therefore the power generated to drive the fan is correspondingly limited. This also precludes the possibility of placing the solar panel at some distance from the ventilator housing to maximize sunlight exposure. Many boats are stored in Recreational Vehicle parking facilities that consist of a roof but no walls, or are stored in other areas with incomplete sunlight exposure. In such a situation, a centrally located solar panel on the top of the boat cover may not be exposed to sufficient sunlight. Although this disadvantage could theoretically be overcome in a different embodiment with the addition of a power cable to the ventilator housing, such a configuration is impractical. The power cable would have to be able to be disconnected from the ventilator housing to allow for storage of the cover, and this would lead to issues in weatherproofing the electrical connection. Furthermore, the location of the ventilator housing on top of an elevated pole, centrally located on the boat and surrounded by the cover, would make attaching and detaching the power cable difficult as it would be physically difficult to reach.

### SUMMARY

A portable powered ventilator is provided that can be easily adapted to multiple boat and cover configurations. The portable powered ventilator generates airflow into the enclosed boat interior to dry the boat interior and thereby inhibit the formation of mold and mildew.

The powered ventilator includes a fan within a housing assembly that is attached to a semi-rigid duct. The housing assembly can have a base to achieve stability, and can be padded to protect the boat. In many embodiments, the duct is semi-rigid to prevent collapse of the duct cross section from the weight of the cover or other pressure resulting from securing the cover. In many embodiments, the duct is expandable longitudinally to increase total length as desired. In many embodiments, the duct is also flexible, allowing the duct to be shaped to the individual configuration of the boat. In many embodiments, the duct is configured to maintain a desired shape unless subjected to reshaping forces greater than typical forces between the duct and the boat cover. In many embodiments, the duct can be reconfigured back into a compressed longitudinal form for storage. In many embodiments, the end of the duct opposite the fan assembly has an end cap configured to protect the boat interior. In many embodiments, the ventilator includes a power cord that includes an on/off switch and is connected to a solar panel by a long cord. The solar panel can be bordered with foam rubber to protect the solar panel from damage. The solar panel can have an attached adjustable strap configured for securing the solar panel. The solar panel can include a metal ring attached to the solar panel to allow the solar panel to be locked to the boat or other stationary object.

### BRIEF DESCRIPTION OF DRAWINGS

FIG. 1 is a schematic diagram of a cross section of a boat and cover, illustrating an example installation and operation of the portable powered ventilator.

FIG. 2 is a side view of the portable powered ventilator of FIG. 1 in which the duct is in an example extended and curved configuration.

FIG. 3 is a side view of the portable powered ventilator of FIG. 1 in which an attached duct is in a longitudinally compressed configuration suitable for storage of the ventilator.

FIG. 4 is a front view of a fan and housing assembly of a portable powered ventilator, in accordance with many embodiments.

FIG. 5 is a front view of a solar panel in accordance with many embodiments, for powering the portable powered ventilator of FIG. 1.

FIG. 6 is a back view of the solar panel of FIG. 5.

### DETAILED DESCRIPTION OF DRAWINGS

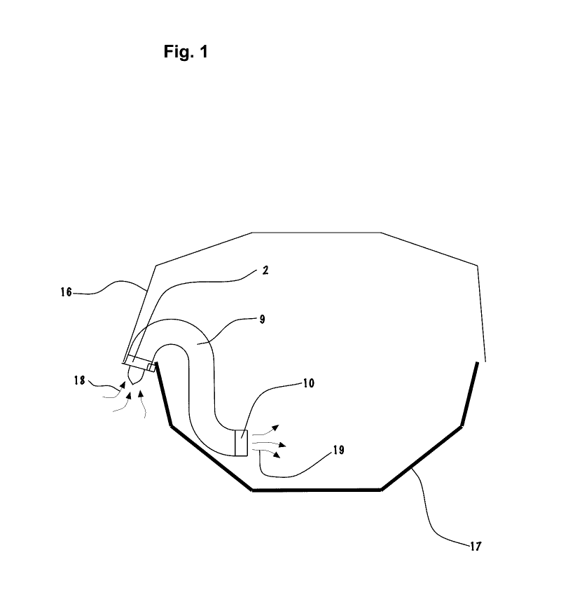

FIG. 1. is a schematic diagram of a cross section of a boat and cover, showing a possible method of application of one embodiment of the portable powered ventilator. This depiction of the portable powered ventilator demonstrates one embodiment with a fan housing assembly 2, the body of a duct 9, and an end cap 10. The fan housing assembly 2 is shown positioned between the boat cover 16 and the hull of the boat 17. Fresh air 18 is drawn into the fan housing assembly 2, carried through the body of the duct 9 and expelled through the end cap 10 thus bringing the expelled air 19 into the interior of the boat. The body of the duct 9 is shown in an extended position that is contoured to the boat interior.

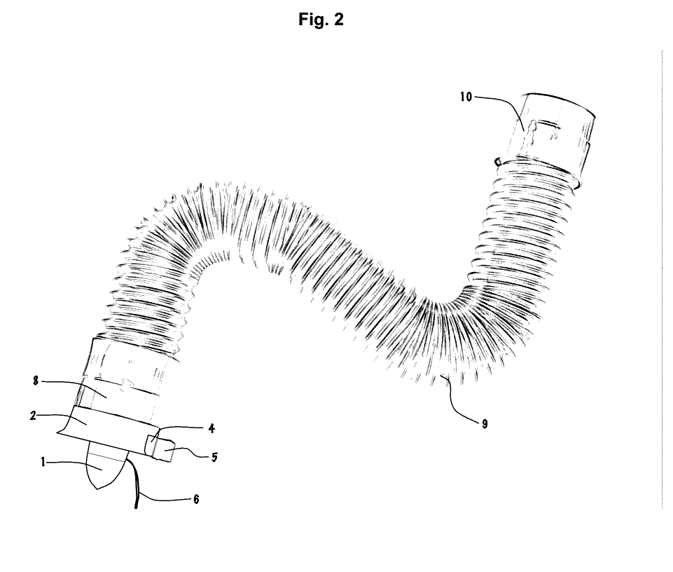

FIG. 2 is a side view of the portable powered ventilator of FIG. 1. The ventilator can have a nose cone 1, which assists in bringing laminar airflow into the housing assembly 2. The housing assembly 2 can have an attached base 4 to add stability to the ventilator. The attached base 4 can have padded feet 5 to protect the boat interior. The housing assembly 2 can have an attached power cord 6 to bring power to the fan. The housing assembly 2 can be connected to the duct 9 by a gasket 8 that provides a seal. The body of the duct 9 can be semi-rigid and can be shaped to the contour of the interior of a boat, demonstrated here in one possible configuration. The duct can terminate with an end cap 10 configured to protect the interior of the boat.

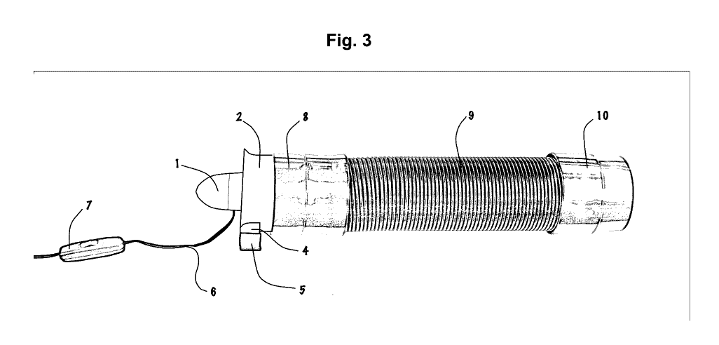

FIG. 3 is also a side view of the portable powered ventilator of FIG. 1. This depiction is identical to FIG. 2 except that the body of the duct 9 has been reconfigured in a compressed longitudinal form suitable for storage of the ventilator. Also depicted here is that the power cord 6 can have an incorporated on/off switch 7.

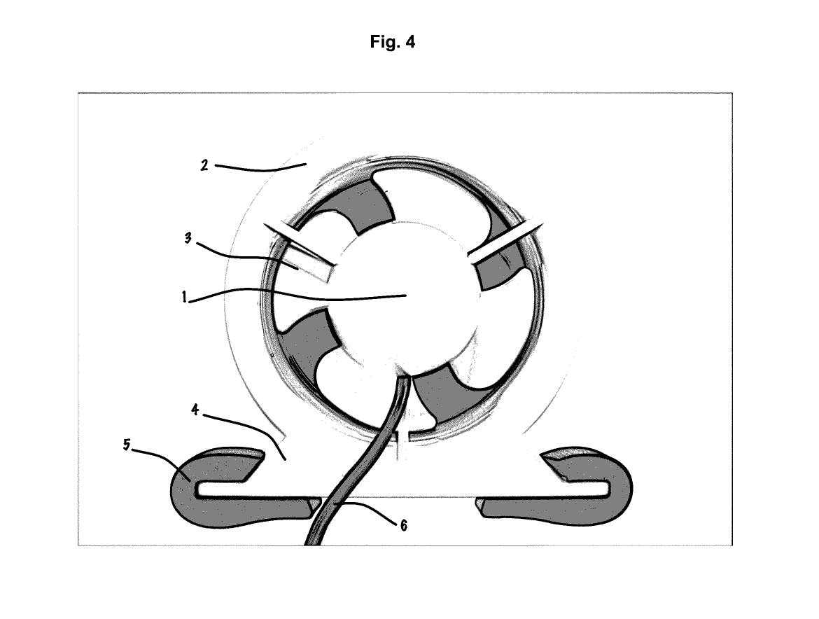

FIG. 4 is a front view of the fan and housing assembly of the portable powered ventilator of FIG. 1 A fan can consist of fan blades 3 that draw fresh air into the housing assembly 2. The fan blades 3 can be preceded by a nose cone 1 that can assist in bringing laminar airflow into the housing assembly 2. A power cord 6 can enter the housing assembly near the base of the nose cone 1 to provide power to the fan. The housing assembly 2 can have a wide base 4 to add rotational stability to the construct. The base 4 can have padded feet 5 to protect the boat.

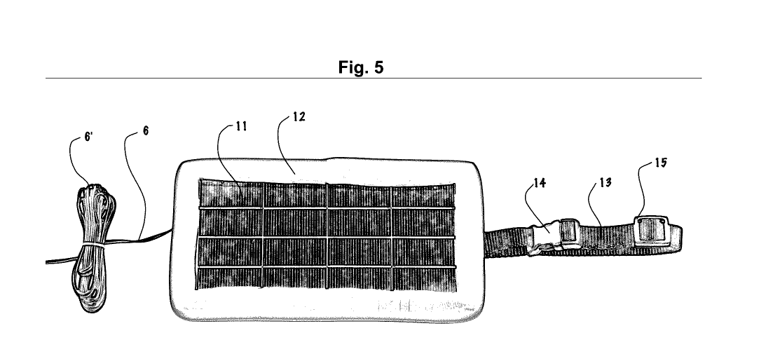

FIG. 5 is a front view of a solar panel in accordance with many embodiments, for powering the portable powered ventilator of FIG. 1. Power is derived from a photovoltaic panel 11, which can be bordered with foam rubber 12 to protect the photovoltaic panel 11 from damage. A power cord 6 carries power to the ventilator and is shown with an area coiled 6′ to demonstrate that the cord can be of an extended length to allow placement of the solar panel some distance away from the ventilator to maximize sunlight exposure of the solar panel. The solar panel can have an attached adjustable strap configured for securing the solar panel. The attached strap can consist of nylon webbing 13 to secure the solar panel. The attached strap can also include a plastic side-release buckle 14 to allow the loop created by the nylon webbing 13 to be opened and closed to easily secure the solar panel. The attached strap can also include a plastic retention slide 15 to allow the loop to have an adjustable length.

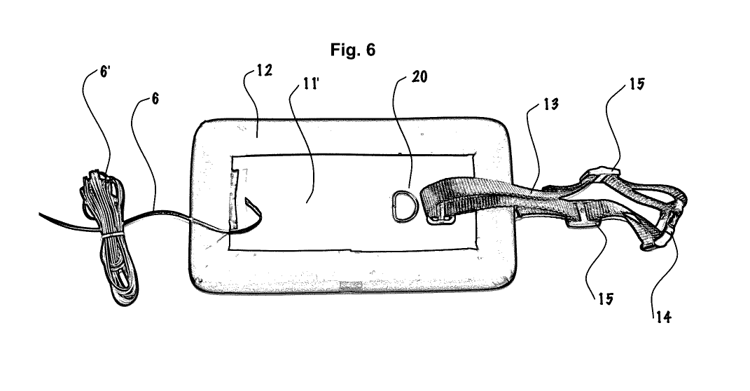

FIG. 6 is a back view of the solar panel of FIG. 5. A power cord 6 can originate from the rear of the photovoltaic panel 11′. The foam rubber border 12 described in FIG. 5 can be continued to cover a portion of the rear of the solar panel to protect the rear of the photovoltaic panel 11′ from damage. A strap consisting of nylon webbing 13 can originate from the rear of the photovoltaic panel 11′. The plastic buckle 14 and retention slide 15 described in FIG. 5 are also visible in this view. A metal ring 20 can be attached to the rear of the photovoltaic panel 11′ to allow for locking the solar panel to the boat or a stationary object.

### Alternative Embodiments

In alternative embodiments, the duct could be longer and less rigid to allow it to be placed such that it terminates within a storage compartment of the boat. This duct would still be rigid to axial compression, but would not retain its shape and would be contoured by gravity as it runs into the interior of the boat. It could also be returned to a longitudinally compressed position for storage.

The solar panel could also be of alternative configurations such as multiple panels that fold for storage. The panels could be protected by different means, such as a padded case made of nylon or plastic. The adjustable strap on the solar panel could be made of different materials, such as a hook-and-loop fastener. In addition, the fan and housing assembly could be connected to municipal power directly, and could be of alternate sizes and shapes to allow for use in applications other than boating.

### Benefits of the Portable Powered Ventilator

The powered ventilator provides numerous advantages. For example, the ventilator provides a portable source of ventilation that is easily adaptable to multiple configurations of boats and covers. The ventilator is easy to employ and in many embodiments does not need to be assembled. The ventilator can be used without having to modify an existing boat cover. The ventilator can be stored separately from the boat cover. The ventilator can be placed on the side of the boat to accommodate easy access to the ventilator. The ventilator can be powered by a suitably sized solar panel depending on power output desired. The solar panel can be placed some distance from the ventilator to maximize sunlight exposure. Other advantages of one or more aspects will be apparent from a consideration of the drawings and ensuing description.

1. A portable powered ventilator for introducing airflow into an enclosed space, the ventilator comprising:
a powered fan operable to generate airflow; and
a semi-rigid duct coupled with the powered fan to conduct the airflow through the duct, the duct being configurable to a collapsed longitudinal configuration and a plurality of deployed contoured configurations, the duct being configured to maintain a selected configuration absent reconfiguration by a user.

2. The portable powered ventilator as recited in claim 1 wherein the fan has a wide base to add stability to the ventilator.

3. The portable powered ventilator as recited in claim 2 wherein the base of the fan has padded feet to protect the ventilated object on which it is placed.

4. The portable powered ventilator as recited in claim 3 wherein the duct has an end cap to protect the ventilated object on which it is placed.

5. The portable powered ventilator as recited in claim 4 wherein said source of electrical energy is a photovoltaic solar panel.

6. The portable powered ventilator as recited in claim 4 wherein said source of electrical energy is a battery.

7. The portable powered ventilator as recited in claim 4 wherein said source of electrical energy is municipal power.

8. The portable powered ventilator as recited in claim 4 wherein said source of electrical energy is any other source of direct or alternating current.

9. The photovoltaic solar panel as recited in claim 5 wherein the border is lined with foam rubber to protect the solar panel from damage.

10. The photovoltaic solar panel as recited in claim 9 further including a power cord of extended length to allow the placement of the solar panel some distance away from the ventilator to maximize sunlight exposure to the solar panel.

11. The photovoltaic solar panel as recited in claim 10 further including an attached adjustable strap with a retention slide and a side-release buckle for securing the solar panel.

12. The photovoltaic solar panel as recited in claim 11 further including a metal ring attached to the rear of the solar panel to allow for locking the solar panel to the boat or a stationary object.
